(19) United States
(12) Patent Application Publication
(10) Pub. No.: US 2004/0016706 A1
(43) Pub. Date: Jan. 29, 2004

(54) Ozone purification system for water

(76) Inventor: Charles M. Minnix, Greenwood, IN (US)

Correspondence Address: BAKER & DANIELS, 300 NORTH MERIDIAN STREET, SUITE 2700, INDIANAPOLIS, IN, 46204-1782, US

(21) Appl. No.: 10/207,142

(22) Filed: Jul. 29, 2002

(51) Int. Cl. C02F 1/78

(52) U.S. Cl. 210/760; 210/194; 210/192; 210/198.1

(57) ABSTRACT

The present invention involves a purification system for water which utilizes repetitive ozone impregnation of the water to create a higher level of ozone for purification and/or sterilization purposes. The system may utilize a water softener and/or reverse osmosis system to remove minerals from the water supplied by a water supplier such as a municipality. Alternatively, demineralized water may be supplied directly to the system. The system includes a pump which receives the water and pumps the water into an expansion tank. From the expansion tank, the water flows through an ozone impregnation device in which the water receives the ozone. After impregnation, water flows into a holding tank. The pump is also in communication with an external demand source such that if ozone impregnated water is needed, water flows back to the pump and is diverted to the source. If no demand sensed, water flows back to the pump and is recycled so that the water is re-impregnated with ozone.

### BACKGROUND OF THE INVENTION

1. Field of Invention

The present invention relates to water treatment systems, specifically those systems which are used to sterilize and cleanse water.

2. Description of the Related Art

Water, as well-known, is a valuable resource for all aspects of life. However, water needs to be cleansed before it can be safely used for human consumption whether as a drink, or in cooking, and must be very clean or sterilized for medicinal purposes such as cleansing cuts, scrapes, bums, and the like. Previous methods of cleansing the water have included the addition of various chemicals to kill pathogens in the water or the use of other systems to remove pathogens from the water; however, these methods may not cleanse the water to the degree necessary for medicinal purposes, such as surgery, burn care, and other intensive and extreme care units.

One common chemical method of cleansing water has been to add large amounts of chlorine to the water in an attempt to kill the microbes and other pathogens existing in the water. A problem with such chlorination is the taste of the water is adversely affected and the chlorine could potentially combine with any organic matter in the water to create undesirable or potentially dangerous compounds. Furthermore, the chlorine may cause adverse reactions in people who are sensitive to chemical chlorine. Even with the chlorination of water by such as, for example, municipal utilities, the water may not be completely free of microbes or may still contain a certain level of microbes, which while deemed safe, may still cause adverse reactions in some people. Other chemical methods have included the use of chlorine in addition to several other chemicals in an attempt to kill or remove all pathogens from the water. Again, even with the use of additional chemicals, some pathogens remain in the water and may cause the undesirable reactions associated with such pathogens.

A relatively common method of removing minerals from the water is the use of a water softener within a home or business. Such water softeners are good for removing minerals, such as iron, which causes a rust appearance on surfaces or hair, and calcium which causes the appearance of hard water stains and scale on surfaces. However, water softeners are not necessarily capable of removing microbes or other pathogens from the water, such pathogens could cause adverse reactions in humans such as nausea or other illness. As such, even with the use of a water softener, other methods or devices for removal of the pathogens and microbes are required to thoroughly cleanse the water and for sterilization of the water.

One attempt to cleanse the water has included the impregnation of ozone into water to assist in killing microbes and other related pathogens, such a system is shown in FIG. 1. A problem with the use of ozone impregnation is that over a certain period of time, the ozone will decay from the O₃ form of oxygen, or ozone, back to the O₂ form of oxygen which does not provide the same benefits of cleaning the water. Thus, the cleaned water is truly clean for a relatively limited period of time. Furthermore, the previous ozone impregnation systems would in general produce a great amount of waste water since the ozone impregnation occurs in one pass, thus once water passes through the ozone impregnation system and the ozone decays, the water becomes waste water and is generally not reused. In addition, the previous ozone impregnation systems is the waste of ozone, or excess ozone, which may come out of solution when the ozonated water is stored, is allowed to be vented from the system and not recovered. Thus, a substantial external supply of ozone is required to continue to impregnate the water since excess ozone, resulting in higher cost and the need for a larger ozone production and storage unit.

Previous systems were problematic in that effluent water was immediately introduced to the ozonation system. The use of such effluent, or contaminated, water requires very large quantities of ozone just to maintain a minimum concentration of ozone in that water since the ozone is performing more than attempted sterilization of the water. Furthermore, the residual ozone in such effluent water is greatly reduced since the ozone is being used to not only attempt to sterilize the water but also to remove all contaminants and minerals. It is known that the higher the quality of the water being used in the ozonation system, the more residual ozone that will remain in the water. In addition, some of these previous ozonation systems would utilize the same tank for holding ozonated water and for introducing the effluent water to the ozonation system, thereby quickly contaminating the ozonated water and reducing the already decreasing ozone level further. Thus, the use of effluent water in the previous ozonation systems presents many problems and hurdles in the sterilization and cleansing of water.

What would be desirable is water sterilization system which provides water that is free of microbes and other pathogens. A water system that provides such sterilized water, which is further free of minerals, would also be desirable.

### SUMMARY OF THE INVENTION

The above-mentioned and described shortcomings are overcome by providing a purification system for water which utilizes repetitive ozone impregnation of the water to maintain at least a predetermined level of ozone. The system may utilize a conventional water softener and/or reverse osmosis system to remove minerals from the water which is supplied by a water supplier such as a municipality. Alternatively, demineralized water may be supplied directly to the purification system. The system includes a pump which receives the water and pumps it into an expansion tank. From the expansion tank the water flows through an ozone generation and impregnation device wherein the water receives the ozone. After impregnation, water flows into a holding tank. The pump is also in communication with an external demand source and if ozone impregnated water is needed, water flows back to the pump and is diverted to the source. If there is no demand sensed, water flows back to the pump and is cycled through the ozone impregnation device again.

The present invention provides a purification system for fluids from a fluid source including a pump having an inlet opening coupled to the fluid source and the pump having at least one outlet opening, and an expansion tank in fluid communication with the pump, wherein fluid may flow through at least one outlet opening into the expansion tank. The purification system further includes an ozone generator with an ozone injector in communication with the expansion tank and arranged to be capable of injecting ozone into the expansion tank, and a holding tank in fluid communication with the expansion tank and connected to the fluid passage. The system also includes a valve in communication with the pump and having a first and a second position, fluid which flows through the system being diverted to an outside area by the valve when the valve is in the first position, and fluid being recycled into the expansion tank when the valve is in the second position.

The present invention further provides a method of purifying water, including providing clean water, pumping the water into an expansion tank, impregnating the water with ozone, passing the ozone impregnated water into a holding tank, and pumping the ozone impregnated water into the expansion tank for further impregnation of ozone.

The present invention further provides a system for purifying water from a water supply including cleansing means in fluid communication with the water supply, a pump in fluid communication with a cleansing means with the pump having a first outlet in communication with an external demand source and a second outlet in communication with an expansion tank, ozone impregnation means in communication with the expansion tank for impregnating ozone into the water which is in the expansion tank to create ozone impregnated water, and means for holding the impregnated water in communication with the ozone impregnation means and the pump. The system also includes means for sensing a demand for the impregnated water, the sensing means in communication with the outlet of the pump and in communication with the external demand source, the sensing means being arranged to be capable of sensing a demand for the impregnated water and diverting the impregnated water to the external demand and when no demand is sensed, water flows from the holding means to the pump and the expansion tank and through the ozone impregnation means in a loop.

The present invention provides a method of irrigating wounds including impregnating water with ozone to a sufficient level to sterilize the water, and pumping the ozone impregnated sterilized water to a wound and flushing the wound with the ozone impregnated sterilized water.

### BRIEF DESCRIPTION OF THE DRAWINGS

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a block schematic diagram of a previous single pass ozonation system;

FIG. 2 is a block schematic diagram of the basic operation of the ozone sterilization system for water, in accordance with the present invention;

FIG. 3 a front perspective view of an embodiment of the ozone sterilization system for water utilizing the basic structure of FIG. 2;

FIG. 4 is a top perspective view of the reverse osmosis system of the ozone sterilization system of FIG. 3;

FIG. 5 is an enlarged fragmentary view of a tap and tee of the ozone sterilization system of FIG. 3;

FIG. 6 is an enlarged fragmentary top view of the ozone sterilization system of FIG. 3;

FIG. 7 is a block schematic diagram of the ozone sterilization system of FIG. 3;

FIG. 8 is a flowchart showing the operative steps in the ozone sterilization system in accordance with the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate two embodiments of the invention and such exemplification is not to be construed as limiting the scope of the invention in any manner.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

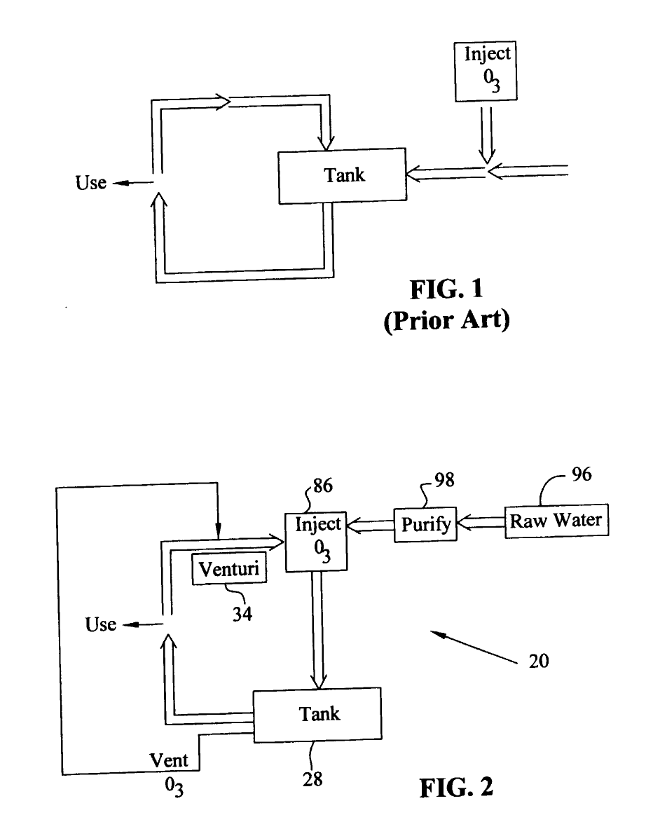

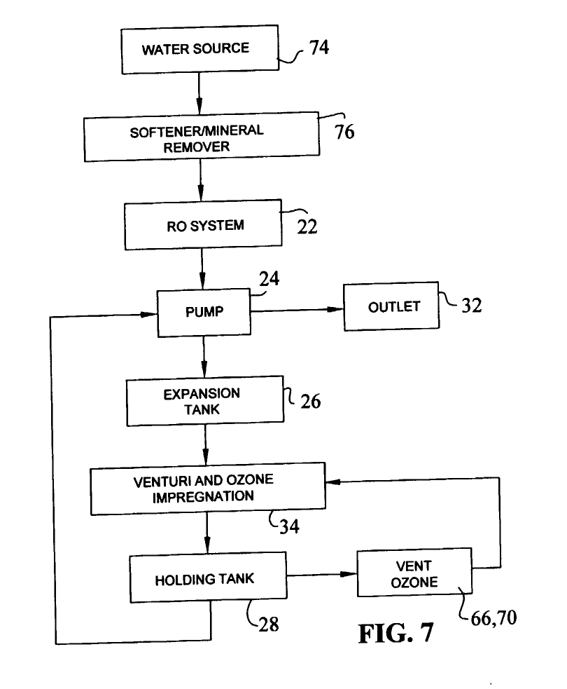

The overall and basic structure of system 20, as shown in FIG. 2, includes receiving raw water 96 from any water source, including city water, well water, or even effluent water, and then passing raw water 96 through cleaning process 98 which may include softener 76 (FIG. 7) and reverse osmosis system 22 (FIG. 7). Cleaning process 98 may also include distillation processes, deionization processes, or other such processes. After cleaning process 98, the water is injected with ozone (block 86) and then sent to a tank, specifically holding tank 28, such as those manufactured by Welimate Water Systems, a division of the Pentair Pump Group of Chardon, Ohio. One noticeable difference between system 20 of FIG. 2 and the previous system of FIG. 1 is cleaning process 98. System 20, with the inclusion of cleaning process 98, may be used in those situations where effluent water is the only water available and yet maintain a similar rate of ozone injection and retention to systems utilizing already demineralized or clean water since the water is cleaned, thereby removing unwanted particulate, minerals, or solvents, prior to injection. The water, after going through cleaning process 98 is considered highly purified water since the formerly effluent water has undergone purifying processes and is suitable for human consumption.

Another difference between the basic structure of system 20 and the previous ozonation system of FIG. 1 is the loop from tank 28 which in system 20 includes ozone injector 34, or if there is no water being used, the water is recycled and re-injected with ozone and then passed to tank 28 rather than merely returning to a holding tank. Thus, the water in holding tank 28 includes a greater level of ozone, due to the re-injection, than that in the holding tank of FIG. 1. Additionally, the ozone concentration is maintained longer since ozone is replaced in the water through the re-injection process. Further details of system 20 are described hereinbelow.

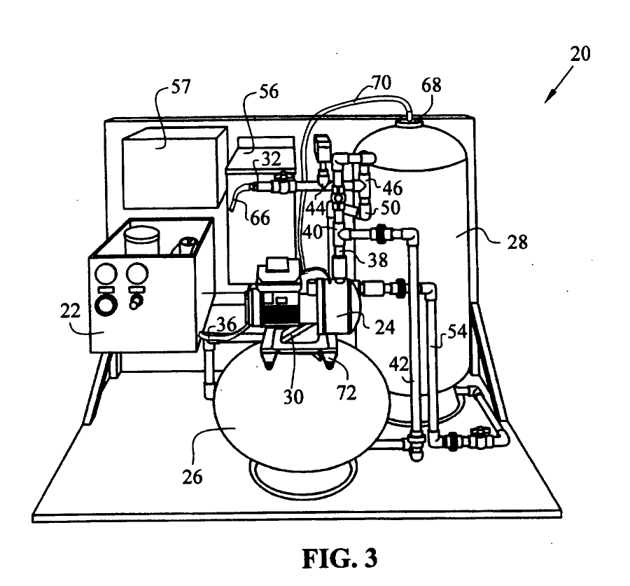

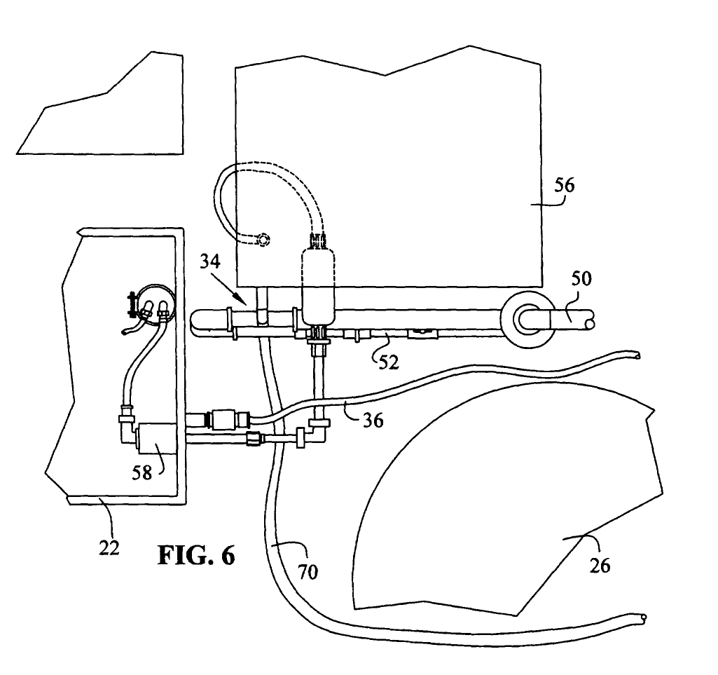

Referring to FIGS. 3, 6, and 7, ozone purification system 20 is shown, with ozone purification system 20 being designed to further purify and/or sterilize water from water source 74. Water flowing from water source 74 passes through softener and mineral remover 76, if the water is not already demineralized, and then into reverse osmosis, or RO, system 22 in which the water is filtered and cleansed. From reverse osmosis system 22, the unpurified and unsterilized, but clean, water passes through inlet pipe 36 and into pump 24 at which point the water is pumped via two-way pipes 38 and 42 into expansion tank 26, which is attached to and supports pump 24 by brackets 72. Pump 24 is of a known type, such as those manufactured by Grundfos Management A/S of Bjerringbro, Denmark and expansion tank 26 is of a known type, such as those manufactured by Wellmate Water Systems, a division of the Pentair Pump Group of Chardon, Ohio. At this point in system 20, the water is still in its unsterilized state, and thus, after leaving expansion tank 26 via pipe 42, tee 40, pipe 44, tee 46, and pipe 50, the water is passed through venturi and ozone impregnation device 34 in which the water is injected with ozone. The level of ozone impregnation may be set to a predetermined value to create purified or sterilized water, depending on the intended use of the water. It is to be noted that second switch, or sensor, 94, attached proximate pump 24, permits water to flow from expansion tank 26 to venturi 34 for impregnation when second sensor 94 senses the level of water in expansion tank 26 exceeds a predetermined level.

The newly ozonated water, upon leaving venturi 34, passes into holding tank 28 via pipe 52. At holding tank 28, the water is held for either super impregnation of ozone by passing through venturi and ozone impregnation device 34 again, or for release to tap 32 when a demand at tap 32 is sensed by pressure switch 30. The ozonated water passes from holding tank 28 via pipe 54 back to pump 24 at which point the ozonated water flows through pipe 38 and to tee 40 at which, if no demand is sensed, the ozonated water then passes through pipe 42 to expansion tank 26 whereupon the ozonated water flows through ozone impregnation device 34, to return to holding tank 28. However, if water demand is sensed, then the ozonated water continues through pipe 44 to tee 46 at which the water flows from tee 46 to pipe 48 and then to outlet 32 and hose 66.

This cycling and super impregnation of the water occurs periodically (possibly continuously) until water demand is sensed by pressure switch 30, resulting in water having a greatly increased level of ozone, and water which maintains that increased level of ozone over a longer period due to the re-impregnation of ozonated water. The highly purified water, which has undergone the ozone impregnation process, is capable of being used as an antiseptic agent or being used in those irrigation processes where an antiseptic agent is desirable.

It is to be noted that the ozone present at ozone impregnation device 34 is produced by ozone generator 56, which is of a conventional type such as, for example, those manufactured by Ozotech of Yreka, Calif. Prior to the ozone generation at ozone generator 56, the oxygen, in its O₂ form is dried by dryer 57, such as those manufactured by the Ozone Division of Net Systems Inc. of Japan. In addition, the excess ozone which comes out of solution in holding tank 28 is vented through ozone vent 68 and passes through tube 70 to be recycled and reinjected at venturi 34, rather than being allowed to vent to the ambient air surrounding ozone sterilization system 20.

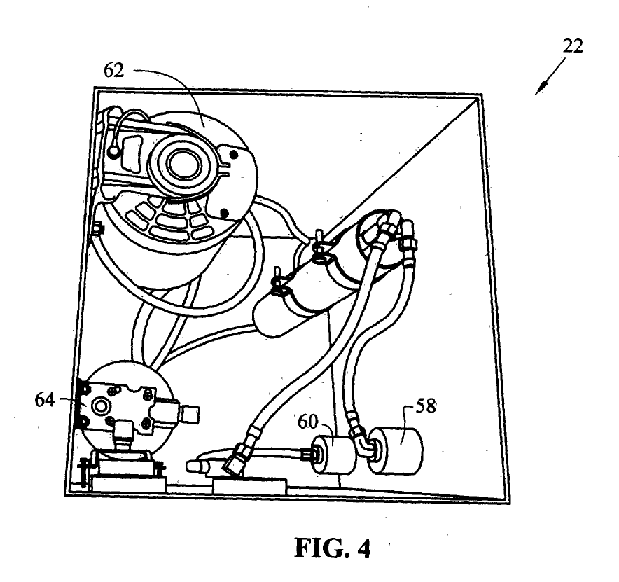

Referring now to FIG. 4, reverse osmosis system 22 is shown in further detail. Reverse osmosis system 22, as described above, filters and cleanses the raw water, thus transforming the water into clean and unsterilized water, before entry into pump 24 and later impregnation with ozone for purification or sterilization purposes. Reverse osmosis system 22 includes dual outlets 58 and 60 for the filtered water, outlet 60 being used to monitor the water quality of the filtered water and to recycle the reverse osmosis concentrate and outlet 58 being connected to inlet pipe 36 of pump 24. Inlet 64 is where water from water source 74, if the water is already demineralized, or from softener and mineral remover 76, if the water has not been demineralized, enters reverse osmosis system 22. From inlet 64 the water passes into filter 62 wherein the reverse osmosis action occurs and the water is filtered. Reverse osmosis system 22 may be of a known design, such as, for example, the Comro line of reverse osmosis systems manufactured by Force Filtration Systems, Inc. of Venice, Fla., or any commercially available reverse osmosis system. It is to be noted, however, that although reverse osmosis system 22 is shown as part of the purification system for water 20, a reverse osmosis system is not required for system 20, other methods of cleansing the raw water may be utilized in place of reverse osmosis system 22 provided the water is purified to a substantially clean level, for example a separate ozone based water cleaning system could be used as the cleaning system for supplying sufficiently clean water to purification system 20.

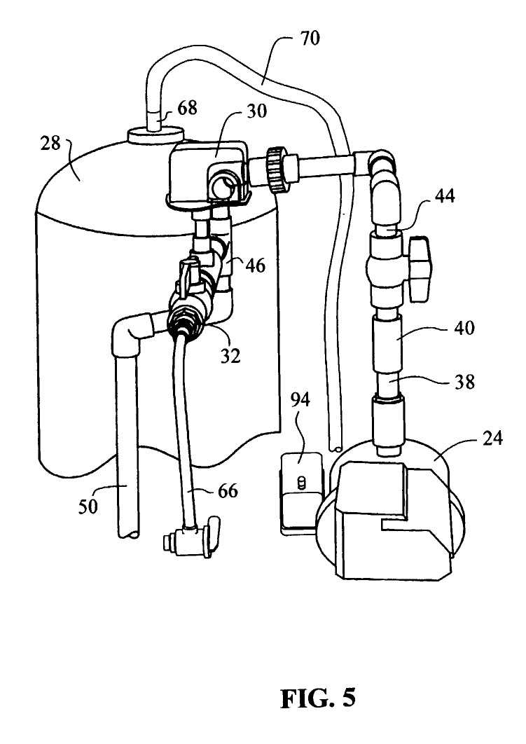

With reference to FIG. 5, the section of purification system 20 at outlet 32 is shown in enlarged detail. As can be seen, there is a direct connection between pump 24 and outlet 32, through pipes 38 and 44, and tees 40 and 46, to outlet 32. At outlet 32 is tube 66, which may be used as a hose to facilitate the drawing of the ozonated water from system 20. Pressure switch 30 is also shown in the system proximate tap 32, where water demand would be placed and sensed by switch 30. Utilizing this water demand sensing enables the water to be cycled back through system 20 when no water demand is sensed. In addition, second pressure switch 94 located proximate pump 24 senses when expansion tank 26 has reached or exceeded a predetermined level, or the pressure has reached or exceeded a maximum pressure and causes pump 24 to push the water to holding tank 28, if second pressure switch 94 senses that holding tank 28 is also not full. In other words, second pressure switch 94 monitors overall system 20 pressure and cycles pump 24 on and off when the water needs to be moved.

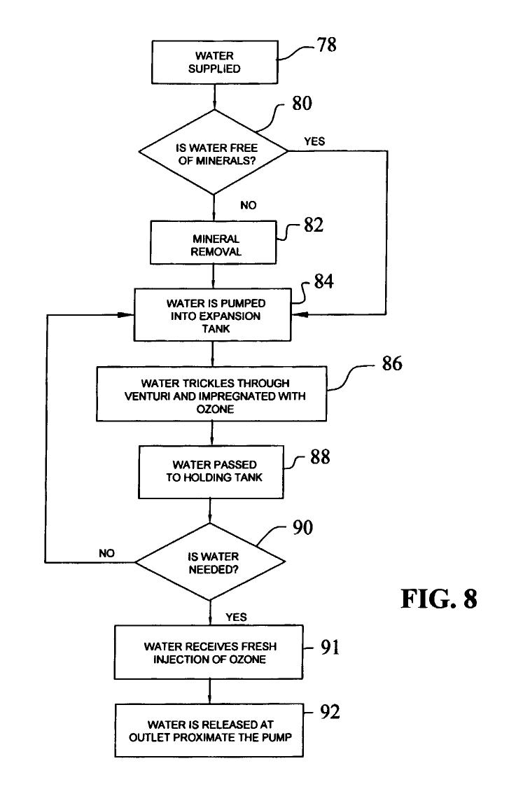

The operation of system 20 will now be described with reference to FIG. 8. At block 78, water is supplied to system 20 from water source 74 with the next step being a determination whether the water has already been demineralized or not (block 80). If the water has not been demineralized, then the water must pass through a mineral removal process at block 82, which may include passing through softener and demineralized 76 and/or reverse osmosis system 22. If the water is already free of minerals, then the water passes directly to pump 24 and the water is pumped into expansion tank 26 at block 84. In either scenario, the water is to be demineralized or otherwise cleaned prior to being injected with ozone. After passing into expansion tank 26, the water passes through venturi and ozone impregnation device 34 and is impregnated with ozone at block 86 with the resultant ozonated water then being passed to holding tank 28 at block 88.

After the water is passed to holding tank 28, a second determination at block 90 must be made concerning whether the ozonated water is needed at tap 32. If ozonated water is needed at tap 32, then the water is released, as described above and shown at block 92. Prior to the release of water, the water receives a fresh injection of ozone (block 91) at pump 24. If ozonated water is not needed at tap 32, then system 20 is structured such that the ozonated water is pumped back into expansion tank 26 via pump 24, as shown at block 84, and then trickles through venturi 34 and is again impregnated with ozone at block 86 with the water again being passed to holding tank 28 at block 88. Thus, the water at outlet 32 has been impregnated with ozone and may have been re-impregnated with ozone numerous times to create a super impregnation or a maintenance of the predetermined concentration of ozone.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A purification system for fluids from a fluid source comprising:
a pump having an inlet opening coupled to the fluid source, said pump further including at least one outlet opening;
an expansion tank in fluid communication with said pump, wherein fluid may flow through at least one outlet opening into said expansion tank;
an ozone generator with an ozone injector in communication with said expansion tank and arranged to be capable of injecting ozone into said expansion tank;
a holding tank in fluid communication with said expansion tank; and
a valve in communication with said pump and having a first and a second position, fluid which flows through said system being diverted to an outside area by said valve when said valve is in said first position, and fluid being recycled into said expansion tank when said valve is in said second position.

2. The system of claim 1, wherein fluid which is recycled into said expansion tank is reinjected with ozone by said ozone injector.

3. The system of claim 1, said ozone injector further comprising a sensor detecting ozone in fluid in said expansion tank.

4. The system of claim 3, wherein an amount of ozone injected into fluid in said expansion tank is adjusted to compensate for ozone sensed in the fluid by said sensor in said ozone injector.

5. The system of claim 1, further comprising a fluid cleanser and demineralizer coupled to the fluid source and to said inlet opening of said pump.

6. The system of claim 5, wherein fluid which flows from said fluid cleanser and demineralizer to said inlet opening is substantially free of minerals and other particulate matter.

7. The system of claim 1, further comprising a vent from said holding tank, said vent in fluid communication with said ozone injector, wherein excess ozone is passed through said vent to fluid from said expansion tank.

8. The system of claim 1 further comprising a second outlet opening on said pump, said second outlet opening in communication with said expansion tank and said first outlet opening in communication with the outside area.

9. The system of claim 8, wherein a diverter is in communication with said pump at said outlet opening and said switch, said diverter having two outlets, a first outlet in communication with said holding tank and a second outlet in communication with the outside area.

10. The system of claim 1 wherein said ozone generator includes a dryer wherein oxygen used by said ozone generator for generation of ozone is dried by said dryer.

11. A method of purifying water, comprising:
providing clean water;
pumping the water into an expansion tank;
impregnating the water with ozone;
passing the ozone impregnated water into a holding tank; and
pumping the ozone impregnated water into the expansion tank for further impregnation of ozone.

12. The method of claim 11 further comprising recovering excess ozone from the holding tank.

13. The method of claim 11 further comprising, after passing the ozone impregnated water into a holding tank:
determining whether there is a demand for ozone impregnated water from an outside demand source;
pumping the ozone impregnated water to an outlet in communication with the outside demand source.

14. The method of claim 13 further comprising repeating the steps of pumping, trickling, and passing of water, when it is determined that ozone impregnated water is not needed at the outside demand source.

15. A system for purifying water from a water supply comprising:
cleansing means in fluid communication with the water supply;
a pump in fluid communication with said cleansing means, said pump having a first outlet in communication with an external demand and a second outlet in communication with an expansion tank;
ozone impregnation means in communication with said expansion tank for impregnating ozone into the water which is in said expansion tank to create ozone impregnated water;
means for holding said impregnated water, said holding means in communication with said ozone impregnation means and said pump; and
means for sensing a demand for said impregnated water, said sensing means in communication with said outlet of said pump and in communication with said external demand said sensing means arranged to be capable of sensing a demand for said impregnated water and diverting said impregnated water to said external demand and when no demand is sensed, water flows from said holding means to said pump and said expansion tank and through said ozone impregnation means in a loop.

16. The system of claim 15 further comprising diverting means at said pump outlet, said impregnated water being diverted to said external demand source by said diverting means.

17. The system of claim 15 wherein said sensing means includes switching means for diverting said water when said means for sensing senses a demand at the outside demand.

18. The system of claim 15 further comprising a venturi, said venturi restricting the amount of said water flowing into said means for holding said impregnated water.

19. The system of claim 15 further comprising means for recovering excess ozone in said means for holding said impregnated water, said means for recovering excess ozone in communication with said ozone generation and impregnation means.

20. The system of claim 15 wherein when said impregnated water is diverted, said impregnated water flows through said first outlet, and when no demand is sensed, said impregnated water flows through said second outlet.

21. A method of irrigating wounds comprising:
impregnating water with ozone to a sufficient level to sterilize the water; and
pumping the ozone impregnated sterilized water to a wound and flushing the wound with the ozone impregnated sterilized water.

22. The method of claim 21 further comprising re-impregnating water with ozone.
